(19) United States
(12) Patent Application Publication
(10) Pub. No.: US 2024/0006656 A1
(43) Pub. Date: Jan. 4, 2024

(54) ALL SOLID BATTERY

(71) Applicant: TAIYO YUDEN CO., LTD., Tokyo (JP)

(72) Inventor: Takato SATO, Tokyo (JP)

(73) Assignee: TAIYO YUDEN CO., LTD., Tokyo (JP)

(21) Appl. No.: 18/251,019

(22) PCT Filed: Oct. 7, 2021
(86) PCT No.: PCT/JP2021/037112

§ 371 Date: Apr. 28, 2023

(30) Foreign Application Priority Data
Nov. 11, 2020 (JP) 2020-188242

(51) Int. Cl. H01M 10/0562; H01M 10/04; H01M 50/591

(52) U.S. Cl. CPC H01M 10/0562; H01M 2300/0068; H01M 50/591; H01M 10/049

(57) ABSTRACT

An all solid battery includes a multilayer structure in which first electrode layers each having a positive electrode active material and a negative electrode active material, solid electrolyte layers, and second electrode layers each having a positive electrode active material and a negative electrode active material are stacked, a thickness of the first electrode layers being different from a thickness of the second electrode layers, the first electrode layers being extracted to a first face of the multilayer structure, the second electrode layers being extracted to a second face of the multilayer structure. A first external electrode is provided on the first face and is connected to the first electrode layers. A second external electrode is provided on the second face and is connected to the second electrode layers.

### TECHNICAL FIELD

The present invention relates to an all solid battery.

### BACKGROUND ART

In recent years, secondary batteries have been used in various fields. A secondary battery using an electrolytic solution has problems such as leakage of the electrolytic solution. Therefore, development of an all solid battery in which a solid electrolyte is provided and other components are also solid is being developed.

The all solid batteries are sometimes subjected to short-circuit tests to confirm their reliability and safety. In the short-circuit tests, whether or not the battery is short-circuited is tested by measuring the electrical resistance of the battery.

If the polarity of the battery is incorrect in the short-circuit inspection, unexpected carrier movement will occur and the battery characteristics will deteriorate. In order to prevent the problem, a nonpolar all solid battery has been proposed in which both the positive electrode and the negative electrode contain both a positive electrode active material and a negative electrode active material (see, for example, Patent Document 1). A non-polar all solid battery in which both the positive electrode and the negative electrode contain an active material having the functions of both the positive electrode active material and the negative electrode active material has also been proposed (for example, Patent Document 2).

### PRIOR ART DOCUMENT

### Patent Document

Patent Document 1: Japanese Patent Application Publication No. 2011-216235 Patent Document 2: International Publication No. 2019/093404

Non-Patent Document 1: The 61^{st} Battery Symposium Summary 3J18

### DISCLOSURE OF THE INVENTION

### Problems to be Solved by the Invention

However, a small non-polar all solid battery mounted on a wiring board or the like has a small capacity, and there is room for improvement in terms of increasing the capacity.

The present invention has been made in view of the above problems, and an object of the present invention is to increase the capacity of an all solid battery.

### Means for Solving the Problems

An all solid battery of the present invention is characterized by including: a multilayer structure in which each of a plurality of first electrode layers each having a first positive electrode active material and a first negative electrode active material, each of a plurality of solid electrolyte layers, and each of a plurality of second electrode layers each having a second positive electrode active material and a second negative electrode active material are stacked, a thickness of the each of a plurality of first electrode layers being different from a thickness of the each of a plurality of second electrode layers, the each of a plurality of first electrode layers being extracted to a first face of the multilayer structure, the each of a plurality of second electrode layers being extracted to a second face of the multilayer structure; a first external electrode that is provided on the first face and is connected to the each of a plurality of first electrode layers; and a second external electrode that is provided on the second face and is connected to the each of a plurality of second electrode layers.

In the above-mentioned all solid battery, the each of a plurality of second electrode layers may be thicker than the each of a plurality of first electrode layers when a first capacity is larger than a second capacity, the each of a plurality of second electrode layers may be thinner than the each of a plurality of first electrode layers when the first capacity is smaller than the second capacity, the first capacity may be determined by a ratio of the first positive electrode active material occupying the each of a plurality of first electrode layers and a theoretical capacity per a weight unit of the first positive electrode active material in the each of a plurality of first electrode layers, and the second capacity may be determined by a ratio of the second negative electrode active material occupying the each of a plurality of second electrode layers and a theoretical capacity per a weight unit of the second negative electrode active material in the each of a plurality of second electrode layers.

In the above-mentioned all solid battery, the multilayer structure may have a third face that is different from the first face and the second face and is parallel with the each of a plurality of first electrode layers and the each of a plurality of second electrode layers, the all solid battery may have a cover layer covering the third face, the all solid battery may have a marker for distinguishing the first external electrode and the second external electrode, and the marker may be provided on the cover layer.

In the above-mentioned all solid battery, a first interval between the marker and the first external electrode may be different from a second interval between the marker and the second external electrode.

In the above-mentioned all solid battery, a shape of the marker may be asymmetrical with respect to a straight line vertical to a direction extending toward the second external electrode from the first external electrode.

### Effects of the Invention

According to the present invention, it is possible to increase capacity of an all solid battery.

### BRIEF DESCRIPTION OF THE DRAWINGS

FIG. 1 is a schematic cross-sectional view illustrating a basic structure of an all solid battery;

FIG. 2 is a top view of an all solid battery;

FIG. 3 is an enlarged cross-sectional view of an all solid battery;

FIG. 4 is an enlarged cross sectional view when a thickness of a second electrode layer is made larger than a thickness of a first electrode layer;

FIG. 5 is a cross-sectional view of a multilayer structure before forming a first external electrode and a second external electrode;

FIG. 6 is a top view showing another embodiment of an all solid battery;

FIG. 7 is a top view illustrating another embodiment of an all solid battery; and

FIG. 8 illustrates a flowchart of a manufacturing method of an all solid battery.

### BEST MODES FOR CARRYING OUT THE INVENTION

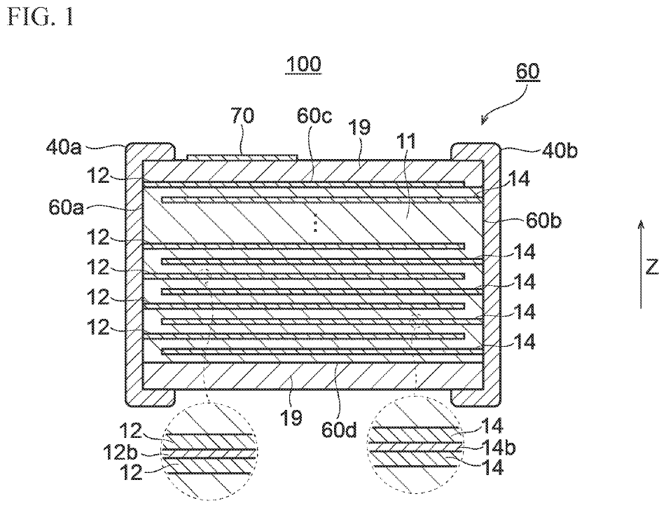

(Embodiment) FIG. 1 is a schematic cross-sectional view illustrating the basic structure of an all solid battery 100. The all solid battery 100 is a nonpolar all solid battery, and has a multilayer structure 60 in which each of a plurality of solid electrolyte layers 11, each of a plurality of first electrode layers 12, and each of a plurality of second electrode layers 14 are stacked. In the multilayer structure 60, the solid electrolyte layer 11 is interposed between the first electrode layer 12 and the second electrode layer 14.

Of these, both the first electrode layer 12 and the second electrode layer 14 are conductive layers containing both the positive electrode active material and the negative electrode active material. Although the positive electrode active material is not particularly limited, a material having an olivine crystal structure is used as the positive electrode active material here. The positive electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

In addition, the negative electrode active material includes, for example, titanium oxide, lithium-titanium composite oxide, lithium-titanium composite phosphate, carbon, and vanadium lithium phosphate.

By using both the positive electrode active material and the negative electrode active material in each of the first electrode layer 12 and the second electrode layer 14 in this manner, the similarity between the electrode layers 12 and 14 is enhanced. As a result, each of the first electrode layer 12 and the second electrode layer 14 functions as both a positive electrode and a negative electrode. Also, it can withstand actual use without malfunctioning in short-circuit inspection. Even if the polarity of the terminal of the all solid battery 100 is reversed, the all solid battery 100 can withstand actual use without malfunctioning in the short-circuit test.

Note that when the first electrode layer 12 and the second electrode layer 14 are made, an oxide-based solid electrolyte material or a conductive aid such as carbon or metal may be added to these electrode layers. Examples of the metal of the conductive aid include Pd, Ni, Cu, and Fe. Furthermore, alloys of these metals may be used as conductive aids.

Also, the layer structures of the first electrode layer 12 and the second electrode layer 14 are not particularly limited. For example, the first electrode layers 12 may be formed on both main faces of a first current collector layer 12b made of a conductive material, as illustrated in the dotted line circle. Similarly, the second electrode layer 14 may be formed on both main faces of the second current collector layer 14b made of a conductive material.

On the other hand, the material of the solid electrolyte layer 11 is phosphoric acid salt-based electrolyte having a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). In order to increase an amount of Li, a part of Ti may be replaced with a transition metal of which a valence is three, such as Al, Ga, In, Y or La. The salt is, for example, Li-Al-M-PO₄-based phosphate (M is Ge, Ti, Zr, or the like) such as Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like.

Li-Al-Ge-PO₄-based material, to which a transition metal included in the phosphoric acid salt in the first electrode layer 12 is added in advance, may be used. For example, when the first internal electrode layer 12 includes phosphoric acid salt including Co and Li, the solid electrolyte layer 11 may include Li-Al-Ge-PO₄-based material to which Co is added in advance. In this case, it is possible to suppress solving of the transition metal from the first electrode active material into the solid electrolyte layer 11.

The multilayer structure 60 has a first face 60a and a second face 60b parallel to the stacking direction Z of the first electrode layer 12 and the second electrode layer 14. Among them, the solid electrolyte layer 11 and the first electrode layer 12 are extracted to the first face 60a. A first external electrode 40a is further provided on the first face 60a, and the first electrode layer 12 is connected to the first external electrode 40a.

On the other hand, the second face 60b faces the first face 60a, and the solid electrolyte layer 11 and the second electrode layer 14 are extracted to the second face 60b. A second external electrode 40b is provided on the second face 60b, and the second electrode layer 14 is connected to the second external electrode 40b on the second face 60b.

Furthermore, the multilayer structure 60 has a third face 60c and a fourth face 60d parallel to the first electrode layer 12 and the second electrode layer 14, respectively. The third face 60c is an upper face that faces upward when the all solid battery 100 is mounted on the wiring board. Further, the fourth face 60d is a lower face which is the lower side during mounting.

In this embodiment, a cover layer 19 for protecting the first electrode layer 12 and the second electrode layer 14 from the atmosphere is formed on each of the third face 60c and the fourth face 60d. The material of the cover layer 19 is also not particularly limited, but the same material as the solid electrolyte layer 11 can be used as the material of the cover layer 19.

The all solid battery 100 described above is a non-polar battery in which each of the first electrode layer 12 and the second electrode layer 14 contains both the positive electrode active material and the negative electrode active material as described above. However, in the present embodiment, the ratio of the area occupied by the positive electrode active material in the cross section of the first electrode layer 12 is made larger than the ratio of the area occupied by the positive electrode active material in the cross section of the second electrode layer 14. As a result, the side of the first external electrode 40a becomes a positive electrode, and the side of the second external electrode 40b becomes a negative electrode. Moreover, the capacity of the all solid battery 100 can be made larger than when the first external electrode 40a side is used as the negative electrode and the second external electrode 40b side is used as the positive electrode. In this embodiment, the polarities of the first external electrode 40a and the second external electrode 40b are determined based on the area ratio, but these polarities may be determined by adopting the weight ratio or the molar ratio.

Although the all solid battery 100 is a non-polar battery, the all solid battery 100 has a suitable polarity for obtaining such a large capacity. Therefore, in this embodiment, a marker 70 for distinguishing between the first external electrode 40a and the second external electrode 40b is provided on the cover layer 19 on the third face 60c side. The position and shape of the marker 70 can be confirmed by a camera or by visual observation, and the first external electrode 40a and the second external electrode 40b can be distinguished based on the position and the shape. Although the thickness of the marker 70 is not particularly limited, the thickness is, for example, about 5 μm to 20 μm in this embodiment. As a result, it is possible to prevent the markers 70 from cracking or peeling off when the markers 70 are fired. Also, the marker 70 may be connected to either the first external electrode 40a or the second external electrode 40b, or may not be necessarily connected to both the external electrodes 40a and 40b.

It should be noted that the color of the marker 70 is preferably different from that of the cover layer 19 so that the marker 70 can be easily recognized. For example, when the cover layer 19 is white, by adding carbon to the marker 70 to make the color black, a clear difference in brightness is generated between the marker 70 and the cover layer 19, which can be visually recognized by a camera. Note that if the marker 70 can be visually recognized without adding carbon, the marker 70 does not need to be added with carbon. In this embodiment, the marker 70 is made of a material different from that of the cover layer 19 and the external electrodes 40a and 40b. Note that the marker 70 may be formed of a material different from that of each of the first electrode layer 12 and the second electrode layer 14.

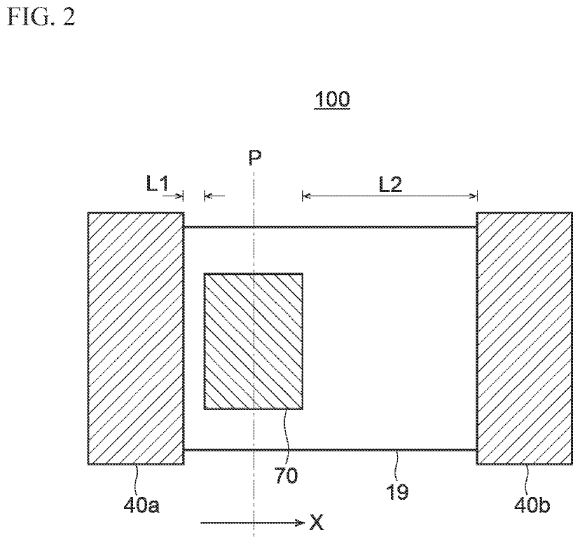

FIG. 2 is a top view of the all solid battery 100. As illustrated in FIG. 2, in the present embodiment, the first external electrode 40a is pointed by the marker 70 by bringing the marker 70 closer to the first external electrode 40a when viewed from above. In this case, the interval L1 between the first external electrode 40a and the marker 70 is shorter than the interval L2 between the second external electrode 40b and the marker 70. Note that the markers 70 may be separated from the external electrodes 40a and 40b by setting each of the intervals L1 and L2 to a value greater than zero.

Also, the shape of the marker 70 is a rectangle symmetrical with respect to a straight line P perpendicular to the direction X from the first external electrode 40a to the second external electrode 40b.

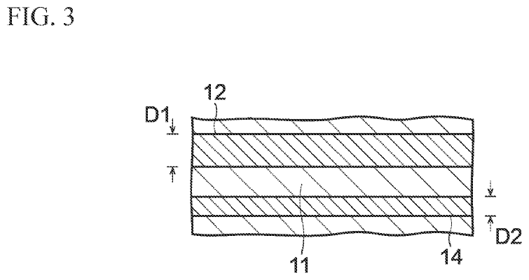

FIG. 3 is an enlarged cross-sectional view of the all solid battery 100. As illustrated in FIG. 3, in this embodiment, the thickness D1 of the first electrode layer 12 is made thicker than the thickness D2 of the second electrode layer 14 so that the thicknesses D1 and D2 are different from each other. As an example, the thickness D1 is approximately 20 μm to 30 μm, and the thickness D2 is approximately 5 μm to 15 μm. Thereby, the capacity of the all solid battery 100 can be increased compared to the case where the thickness D1 of the first electrode layer 12 is the same as the thickness D2 of the second electrode layer 14. If the thickness D1 of the first electrode layer 12 is blindly increased, the capacity on the positive electrode side becomes too large compared to that on the negative electrode side, resulting in a capacity imbalance between the positive electrode side and the negative electrode side. To avoid this problem, the thickness of the first electrode layer 12 or the second electrode layer 14 should be determined based on the theoretical value of the capacity as follows.

“cₚ” (Ah/g) is the theoretical capacity per unit weight of the positive electrode active material, and “pₚ” (g/cm³) is the density of the positive electrode active material. Also, as illustrated in FIG. 3, the thickness of the first electrode layer 12 is D1 (cm), and the area of the first electrode layer 12 is “Sₚ” (cm²). Furthermore, “Aₚ” (%) is the ratio of the area occupied by the positive electrode active material in the first electrode layer 12. At this time, the first capacity “Cₚ” (Ah/g) of the single first electrode layer 12 is cₚ×pₚ×D1×Sₚ×Aₚ.

Note that the ratio Aₚ is obtained by observing a cross section of the first electrode layer 12 parallel to the stacking direction Z (see FIG. 1) by SEM (Scanning Electron Microscope)-EDS (Energy Dispersive X-ray Spectroscopy) mapping and specifying the proportion of the exposed cross section occupied by elements specific to the positive electrode active material.

Similarly, “cₙ” (Ah/g) is the theoretical capacity per unit weight of the negative electrode active material, and “pₙ” (g/cm³) is the density of the negative electrode active material. Also, as illustrated in FIG. 3, the thickness of the second electrode layer 14 is D2 (cm), and the area of the second electrode layer 14 is “Sₙ” (cm²). Furthermore, the ratio of the area occupied by the negative electrode active material in the second electrode layer 14 is defined as “Aₙ” (%). In this case, the second capacity “Cₙ” (Ah/g) of the single second electrode layer 14 is cₙ×pₙ×Tₙ×Sₙ×Aₙ.

Note that the ratio “Aₙ” is obtained by observing a cross section of the second electrode layer 14 parallel to the stacking direction Z (see FIG. 1) by SEM-EDS mapping, and specifying the proportion of the exposed cross section occupied by elements specific to the negative electrode active material.

When the first capacity Cₚ obtained in this manner is smaller than the second capacity Cₙ, the difference between the capacities on the positive electrode side and the negative electrode side becomes smaller by making the thickness D2 smaller than the thickness D1 as illustrated in FIG. 3, and the imbalance between the capacities on the positive electrode side and the negative electrode side can be reduced.

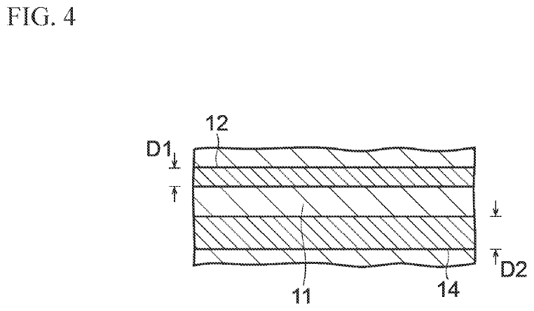

On the other hand, when the first capacity Cₚ is larger than the second capacity Cₙ, the difference between the capacities on the positive electrode side and the negative electrode side becomes smaller by making the thickness D2 larger than the thickness D1, and the imbalance between the capacities on the positive electrode side and the negative electrode side can be reduced. FIG. 4 is an enlarged cross sectional view when the thickness D2 is made larger than the thickness D1.

Note the thickness D1, D2 of each of the first electrode layer 12 and the second electrode layer 14 may be adjusted so that the difference ΔC between the total value C_{p_all} of the first capacities Cp of all the first electrode layers 12 and the total value C_{n_all} of the second capacities Cₙ of all the second electrode layers 14 is made as small as possible. For example, the imbalance of the capacities on the positive electrode side and the negative electrode side may be adjusted by adjusting the thicknesses D1 and D2 of each of the first electrode layer 12 and the second electrode layer 14 so that ΔC is ±15% or less of C_{p_all}, more preferably ±5% or less.

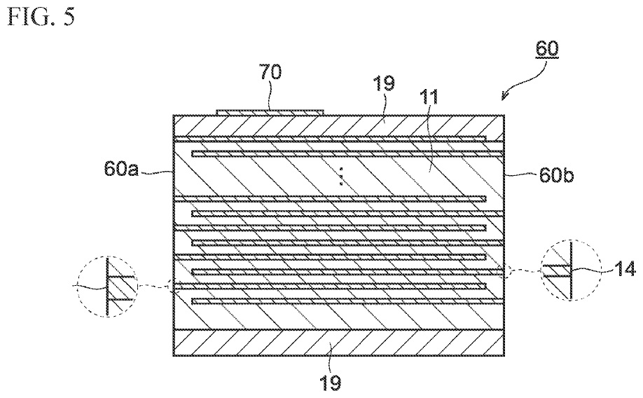

FIG. 5 is a cross-sectional view of the multilayer structure 60 before forming the first external electrode 40a and the second external electrode 40b. As illustrated in FIG. 5, before the external electrodes 40a and 40b are formed, the first electrode layer 12 is extracted to the first face 60a and the second electrode layer 14 is extracted to the second face 60b.

At this time, since the thicknesses D1 and D2 of the electrode layers 12 and 14 are different in this embodiment as described above, the thicknesses of the electrode layers 12 and 14 extracted to the faces 60a and 60b are also different. Therefore, even if the marker 70 is peeled off due to an external force or the like before the external electrodes 40a and 40b are formed, the difference in thickness of the electrode layers 12 and 14 extracted to the respective faces 60a and 60b can be detected by a camera or an operator, the polarity of the all solid battery 100 can be determined.

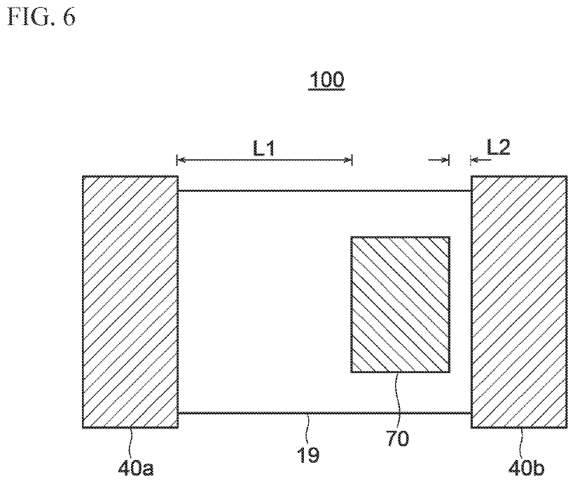

FIG. 6 is a top view showing another embodiment of the all solid battery. In the example of FIG. 6, the second external electrode 40b is indicated by the marker 70 by making the interval L2 smaller than the interval L1 and bringing the marker 70 closer to the second external electrode 40b.

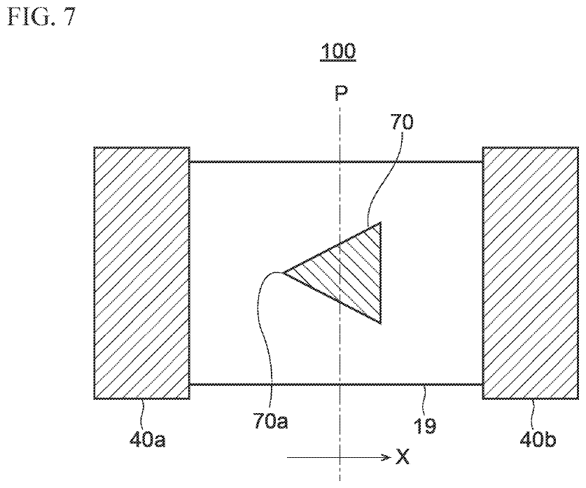

FIG. 7 is a top view illustrating another embodiment of the all solid battery. In the example of FIG. 7, the marker 70 having a triangle shape is provided substantially in the center of the all solid battery 100 in top view. By directing the vertex 70a of the marker 70 toward the first external electrode 40a, the marker 70 points to the first external electrode 40a.

In this case, the shape of the marker 70 is asymmetric with respect to the straight line P perpendicular to the direction X from the first external electrode 40a to the second external electrode 40b. Such asymmetry allows a person or a camera to distinguish between the first external electrode 40a and the second external electrode 40b.

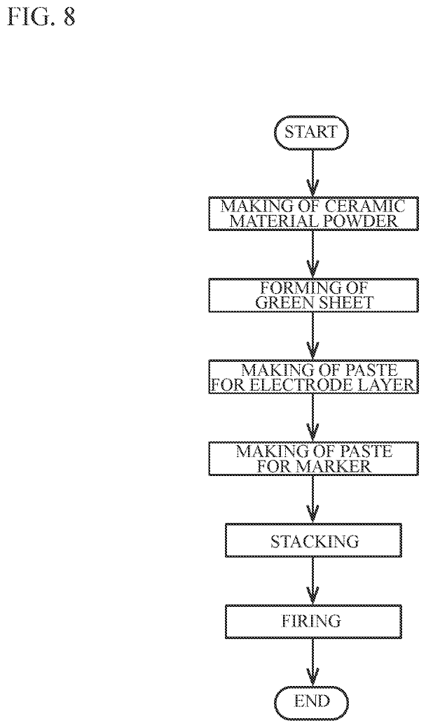

A description will be given of a manufacturing method of the all solid battery of the present embodiment. FIG. 8 illustrates a flowchart of the manufacturing method of the all solid battery.

(Making process of ceramic material powder) First, powder of the phosphate-based solid electrolyte that constitutes the solid electrolyte layer 11 described above is prepared. For example, the powder of the phosphate-based solid electrolyte that constitutes the solid electrolyte layer 11 can be produced by mixing raw materials and additives and using a solid-phase synthesis method or the like. A desired average particle size can be obtained by dry pulverizing the obtained powder. For example, a planetary ball mill using ZrO₂ balls of 5 mm φ is used to adjust the desired average particle size.

Additives include sintering aids. As the sintering aid, for example, any glass component such as Li-B-O based compounds, Li-Si-O based compounds, Li-C-O based compounds, Li-S-O based compounds, and Li-P-O based compounds can be used.

(Forming process of green sheet) Next, the obtained powder is uniformly dispersed in an aqueous solvent or an organic solvent together with a binder, a dispersant, a plasticizer, or the like, and wet pulverized to obtain a solid electrolyte slurry having a desired average particle size. At this time, a bead mill, a wet jet mill, various kneaders, a high-pressure homogenizer, or the like can be used, and it is preferable to use a bead mill from the viewpoint of being able to simultaneously adjust the particle size distribution and disperse the particles.

Then, a binder is added to the obtained solid electrolyte slurry to obtain a solid electrolyte paste. A green sheet for the solid electrolyte layer 11 is obtained by applying the solid electrolyte paste. A green sheet for the cover layer 19 can also be formed in the same manner. The applying method is not particularly limited, and a slot die method, a reverse coating method, a gravure coating method, a bar coating method, a doctor blade method, or the like can be used. The particle size distribution after wet pulverization can be measured, for example, using a laser diffraction measurement device using a laser diffraction scattering method.

(Making process of paste for electrode layer) Next, a paste for an electrode layer paste for forming the first electrode layer 12 and the second electrode layer 14 is made. For example, a positive electrode active material, a negative electrode active material, and a solid electrolyte material are highly dispersed in a bead mill or the like to prepare a ceramic paste consisting only of ceramic particles. Alternatively, a carbon paste containing carbon particles such as carbon black may be prepared, and the carbon paste may be kneaded with the ceramic paste.

(Marker paste production process) Next, a paste for marker for making the marker 70 described above is made. Here, the paste for marker is made by kneading ceramic particles with carbon particles such as carbon black.

(Stacking process) The paste for electrode layer is printed on one main face of the green sheet. The green sheets after printing are stacked so that each of the green sheets is alternately shifted to each other so that the multilayer structure 60 is obtained. After that, cover sheets for the cover layer 19 are stacked on each of the third face 60c and the fourth face 60d of the multilayer structure 60. Then, the paste for the marker 70 is printed on the uppermost green sheet.

(Firing process) Next, the multilayer structure 60 is fired in a firing atmosphere containing oxygen. In order to suppress disappearance of the carbon material contained in the paste for electrode layer, the oxygen partial pressure in the firing atmosphere is preferably 2×10⁻¹³ atm or less. On the other hand, it is preferable to set the oxygen partial pressure to 5×10⁻²² atm or more in order to suppress the melting of the phosphate-based solid electrolyte.

After that, the first external electrode 40a and the second external electrode 40b are formed by applying a metal paste to each of the faces 60a and 60b of the multilayer structure 60 and firing the multilayer structure 60. Alternatively, the first external electrode 40a and the second external electrode 40b may be formed by sputtering or plating. With the above processes, the basic structure of the all solid battery 100 is completed.

### EXAMPLES

(Example 1) All solid batteries according to Examples 1 to 5 and Comparative Example 1 were produced as follows. First, Co₃O₄, Li₂CO₃, ammonium dihydrogen phosphate, Al₂O₃, and GeO₂ were mixed to produce Li_{1.3}Al_{0.3}Ge_{1.7}(PO₄)₃ containing a predetermined amount of Co as a solid electrolyte material powder by a solid phase synthesis method. The obtained powder was dry-pulverized with ZrO₂ balls. Furthermore, a solid electrolyte slurry was prepared by wet pulverization using ion-exchanged water or ethanol as a dispersion medium. A binder was added to the obtained slurry to obtain a solid electrolyte paste, and a green sheet was formed. LiCoPO₄ and Li_{1.3}Al_{0.3}Ti_{1.7}(PO₄)₃ containing a predetermined amount of Co were synthesized by solid phase synthesis in the same manner as above.

In Examples 1 to 5, the positive electrode active material, the negative electrode active material, and the solid electrolyte material were highly dispersed using a wet bead mill or the like to prepare a ceramic paste consisting only of ceramic particles. Next, the ceramic paste and the conductive aid were thoroughly mixed to prepare an electrode layer paste for forming the first electrode layer 12 and the second electrode layer 14.

LiCoPO₄ was used as the positive electrode active material. Li₁₊ₓAlₓTi₂₋ₓ(PO₄)₃ was used as the negative electrode active material. In addition, the paste for electrode layer was made so that the ratio of the area occupied by the positive electrode active material in the cross section of the first electrode layer 12 after firing was larger than the ratio of the area occupied by the positive electrode active material in the cross section of the second electrode layer 14.

The paste for electrode layer was printed on the green sheet by screen printing. The multilayer structure was made by stacking 11 printed green sheets while shifting them to the left and right so that the electrodes were pulled out. A plurality of green sheets were attached as the cover layers 19 above and below the multilayer structure 60. After that, the green sheets were pressed together by hot pressing, and the multilayer structure 60 was cut into a predetermined size by a dicer.

The cut multilayer structure 60 was heat-treated at 300° C. or higher and 500° C. or lower for removing the binder, and heat-treated at 900° C. or lower for sintering. A cross-section of the sintered multilayer structure 60 was observed with an SEM to identify a region where the conductive aid was present. The regions were identified as the first electrode layer 12 and the second electrode layer 14, and the thicknesses of these electrode layers 12 and 14 were measured.

As a result, in Example 1, the thickness D1 of the first electrode layer 12 was 10 μm, and the thickness D2 of the second electrode layer 14 was 12 μm.

(Example 2) In Example 2, the thickness D1 of the first electrode layer 12 was 10 μm, and the thickness D2 of the second electrode layer 14 was 15 μm.

(Example 3) In Example 3, the thickness D1 of the first electrode layer 12 was 10 μm, and the thickness D2 of the second electrode layer 14 was 20 μm.

(Example 4) In Example 4, the thickness D1 of the first electrode layer 12 was 10 μm, and the thickness D2 of the second electrode layer 14 was 50 μm.

(Example 5) In Example 5, the thickness D1 of the first electrode layer 12 was 10 μm, and the thickness D2 of the second electrode layer 14 was 100 μm.

(Comparative example 1) In Comparative Example a, only the positive electrode active material was used as the electrode active material of the first electrode layer 12, and the negative electrode active material was not used. In addition, only the negative electrode active material was used as the electrode active material of the second electrode layer 14, and the positive electrode active material was not used. As a result, the all solid battery according to Comparative Example did not become a non-polar battery, but became a battery having polarity. The thickness D1 of the first electrode layer 12 was 10 μm, and the thickness D2 of the second electrode layer 14 was 10 μm.

Next, the capacities of the all solid batteries of Examples 1 to 5 and Comparative Example 1 were measured. Further, Examples 1 to 5 and Comparative Example 1 were examined to determine whether the polarity of the all solid battery can be determined by visually checking the thickness of each electrode layer 12 and 14 when the marker 70 was peeled off. Table 1 shows the results.

TABLE 1

| | | THICKNESS | THICKNESS | | | | |
|---|---|---|---|---|---|---|---|
| | | OF 1st | OF 2nd | POLARITY | | | |
| | | ELECTRODE | ELECTRODE | DURING | POLARITY | | |
| | LARGER ONE | LAYER 12 | LAYER 14 | SHORT- | DETERMINATION | | TOTAL |
| | OF Cₚ AND Cₙ | (μm) | (μm) | CIRCUIT TEST | BY APPEARANCE | CAPACITY | EVALUATION |
| EXAMPLE 1 | 1st CAPACITY Cp | 10 | 12 | ◯ | Δ | ◯ | Δ |
| EXAMPLE 2 | 1st CAPACITY Cp | 10 | 15 | ◯ | ◯ | ◯ | ◯ |
| EXAMPLE 3 | 1st CAPACITY Cp | 10 | 20 | ◯ | ◯ | ◯ | ◯ |
| EXAMPLE 4 | 1st CAPACITY Cp | 10 | 50 | ◯ | ◯ | Δ | Δ |
| EXAMPLE 5 | 1st CAPACITY Cp | 10 | 100 | ◯ | ◯ | Δ | Δ |
| COMPARATIVE | 1st CAPACITY Cp | 10 | 10 | × | × | × | × |
| EXAMPLE 1 | | | | | | | |

In Table 1, “larger one of capacities Cₚ and Cₙ” indicates which of the first capacity Cₚ and the second capacity Cₙ is larger.

“polarity during short-circuit test” was judged as “○” when it was possible to perform the test even if the polarity was reversed during short-circuit test, and “x” when it was impossible to perform the test even if the polarity was reversed during short-circuit test.

“polarity determination by appearance” was judged as “○” when the polarity could be easily determined by visually recognizing the difference in thickness D1 and D2 of each of the first electrode layer 12 and the second electrode layer 14. When the polarity was not easily determined but could be determined, “polarity determination by appearance” was judged as “Δ”. Also, when the polarity could not be determined by visually recognizing the difference between the thicknesses D1 and D2, “polarity determination by appearance” was judged as “x”.

“capacity” was calculated as follows. First, the discharge capacity Q (mAh) at A-0.5 (V) was measured. Next, charging was performed at a constant current I, and the voltage change ΔV between the external electrodes 40a and 40b immediately after the charging was started was measured. A value obtained by multiplying the obtained resistance R (=ΔV/I) by the discharge capacity Q was defined as a capacity C (mAh·Ω). When the capacity C was 2,500 mAh·Ω or more, “capacity” was judged as “○”, and when the capacity C was 1,000 mAh·Ω or more and less than 2,500, “capacity” was judged as “Δ”. And, when the capacity C was less than 1000 mAh·Ω, “capacity” was judged as “x”.

In addition, “total evaluation” was judged as “x” when at least one of “polarity during short-circuit test”, “polarity determination by appearance”, and “capacity” was judged as “x”. In addition, if none of “polarity during short-circuit test”, “polarity determination by appearance”, and “capacity” were judged as “x”, but not all of them were judged as “○”, “total evaluation” was judged as “Δ”. When all of “polarity during short-circuit test”, “polarity determination by appearance”, and “capacity” were judged as “○”, “total evaluation” was also judged as “○”.

As shown in Table 1, in Example 1, since each of the first electrode layer 12 and the second electrode layer 14 contained the positive electrode active material and the negative electrode active material, the all solid battery 100 was non-polar. “Polarity during short-circuit test” was judged as “○”. This also applied to Examples 2 to 5.

In addition, although the difference in thickness between the electrode layers 12 and 14 was as small as 2 μm, “polarity determination by appearance” in Example 1 was judged as “Δ” because the difference was visible. In addition, “capacity” was judged as “○”. As a result, the “total evaluation” of Example 1 was judged as “Δ”.

On the other hand, in Example 2, the difference in thickness between the electrode layers 12 and 14 was as large as 5 μm, so the “polarity determination by appearance” was judged as “○”. In addition, “capacity” of Example 2 was also judged as “○”. As a result, “total evaluation” of Example 2 was judged as “○”.

Similarly, in Example 3, both “polarity determination by appearance” and “capacity” were judged as “○”, and “total evaluation” was also judged as “○”. In Example 4, the difference in thickness between the electrode layers 12 and 14 was as large as 40 μm, so “polarity determination by appearance” was judged as “○”. However, “capacity” was judged as “Δ”. As a result, “total evaluation” of Example 4 was judged as “Δ”.

Also in Example 5, the difference in thickness between the electrode layers 12 and 14 was as large as 90 μm, so “polarity determination by appearance” was judged as “○”, but “capacity” was judged as “Δ”. As a result, “total evaluation” of Example 5 was also judged as “Δ”.

On the other hand, since the all solid battery according to Comparative Example 1 was a battery with polarity as described above, “polarity during short-circuit test” was judged as “x”. In addition, in Comparative Example 1, since there was no difference in the thicknesses of the electrode layers 12 and 14, “polarity determination by appearance” was also judged as “x”. Furthermore, “capacity” was also judged as “x”, and “total evaluation” was judged as “x”.

Although the embodiments of the present invention have been described in detail, it is to be understood that the various change, substitutions, and alterations could be made hereto without departing from the spirit and scope of the invention.

1. An all solid battery comprising:
a multilayer structure in which each of a plurality of first electrode layers each having a first positive electrode active material and a first negative electrode active material, each of a plurality of solid electrolyte layers, and each of a plurality of second electrode layers each having a second positive electrode active material and a second negative electrode active material are stacked, a thickness of the each of a plurality of first electrode layers being different from a thickness of the each of a plurality of second electrode layers, the each of a plurality of first electrode layers being extracted to a first face of the multilayer structure, the each of a plurality of second electrode layers being extracted to a second face of the multilayer structure;
a first external electrode that is provided on the first face and is connected to the each of a plurality of first electrode layers; and
a second external electrode that is provided on the second face and is connected to the each of a plurality of second electrode layers.

2. The all solid battery as claimed in claim 1,
wherein:
the each of a plurality of second electrode layers is thicker than the each of a plurality of first electrode layers when a first capacity is larger than a second capacity,
the each of a plurality of second electrode layers is thinner than the each of a plurality of first electrode layers when the first capacity is smaller than the second capacity,
the first capacity is determined by a ratio of the first positive electrode active material occupying the each of a plurality of first electrode layers and a theoretical capacity per a weight unit of the first positive electrode active material in the each of a plurality of first electrode layers, and
the second capacity is determined by a ratio of the second negative electrode active material occupying the each of a plurality of second electrode layers and a theoretical capacity per a weight unit of the second negative electrode active material in the each of a plurality of second electrode layers.

3. The all solid battery as claimed in claim 1,
wherein:
the multilayer structure has a third face that is different from the first face and the second face and is parallel with the each of a plurality of first electrode layers and the each of a plurality of second electrode layers,
the all solid battery has a cover layer covering the third face,
the all solid battery has a marker for distinguishing the first external electrode and the second external electrode, and
the marker is provided on the cover layer.

4. The all solid battery as claimed in claim 3,
wherein
a first interval between the marker and the first external electrode is different from a second interval between the marker and the second external electrode.

5. The all solid battery as claimed in claim 3,
wherein
a shape of the marker is asymmetrical with respect to a straight line vertical to a direction extending toward the second external electrode from the first external electrode.
